(19) United States
(12) Patent Application Publication
(10) Pub. No.: US 2008/0286633 A1
(43) Pub. Date: Nov. 20, 2008

(54) Circuit testing device for solid oxide fuel cell

(76) Inventors: Kathleen Ritter Olenick, Buffalo, NY (US); Andrew David Urban, Tonawanda, NY (US)

Correspondence Address: CORNING INCORPORATED, SP-TI-3-1, CORNING, NY, 14831, US

(21) Appl. No.: 11/804,064

(22) Filed: May 17, 2007

(51) Int. Cl. H01M 10/48

(52) U.S. Cl. 429/90

(57) ABSTRACT

A device for testing the circuitry of a ceramic sheet-type, multi-cell solid oxide fuel cell is provided. The testing device includes a support plate having a substantially flat face, and a plurality of resilient contacts mounted on the flat face of the support plate. The contacts are spaced-apart so that each contact is individually registrable with one of the plurality of spaced-apart cells when the support plate of the device is positioned over fuel cell, allowing the circuit integrity of all of the cells to be tested simultaneously. The support plate includes a light conducting portion that visually facilitates alignment and engagement between said resilient contact members and the cells when the device is positioned over the solid oxide fuel cell. The light conducting portion of the support plate may be a transparent material that forms all or part of the plate. The resilient contacts each engage a sufficiently broad area of the cells to avoid localized stresses in the ceramic sheet that may otherwise provide sites for unwanted cracking or other types of damage.

### FIELD OF THE INVENTION

This invention generally relates to circuit testing devices, and is specifically concerned with a circuit testing device for a ceramic sheet type multi-cell solid oxide fuel cell.

### BACKGROUND OF THE INVENTION

Solid oxide fuel cells (SOFC) are well known in the prior art. The essential components of a solid oxide fuel cell include a dense, oxygen-ion-conducting electrolyte sandwiched between porous, conducting metal, cermet, or ceramic electrodes. Electrical current is generated in such cells by the oxidation, at the anode, of a fuel material such as hydrogen which reacts with oxygen ions conducted through the electrolyte from the cathode.

While several different designs for solid oxide fuel cells have been developed, including, for example, a supported tubular arrangement of interconnected segmented cells, one of the most promising is a planar design of flat, individual cells connected in series and supported by a thin, flexible sheet formed from a ceramic material that also serves as an electrolyte. A single cell is formed by applying single electrodes to each side of the ceramic electrolyte sheet to provide an electrode-electrolyte-electrode laminate. Typically, eight to sixteen of these single cells are arrayed or “stacked” along the length of the supporting ceramic electrolyte sheet and connected in series to build voltage. The cells are usually rectangular in shape, and are arranged with their lengthwise edges parallel to and separated from the lengthwise edges of adjacent cells by short distances of a millimeter or two.

The short distances between the individual cells on the supporting ceramic electrolyte sheet raises the possibility that short circuits and other circuit defects may occur between the individual cells during manufacture when, for example, the electrodes are formed over the sheet. Accordingly it is desirable, for quality control purposes, to check the integrity of the circuitry in the fuel cell at various stages during manufacture. Presently such multi-cell, ceramic sheet type fuel cells are circuit checked using hand held probes. While the use of such hand-held probes can effectively detect short circuits and other electrical defects between adjacent cells, the applicants have observed a number of shortcomings associated with this technique. For example, hand probing multiple cells on the thin ceramic sheet can easily cause point contact damage and therefore requires careful operator training and experience. To lower the chances of damaging the fuel cells, the probes must be mechanically altered to soften the tips, and the tip-softening methods are not very reproducible. In operation, the probes are connected to an ohm meter or multimeter, and an individual resistance reading is required between each contact pair. This is time consuming and a potential source of error, particularly since many multi-cell, ceramic sheet-type fuel cells have sixteen or more individual cells.

To speed up the checking operation, the applicants considered using ganged probe mechanism having a number of probe tips to allow all adjacent pairs of cells to be check simultaneously. However, the multiple probe tips on gang probe mechanisms are often not accurately co-planar, therefore either causing some probe tips to generate point contact damage on the ceramic sheet while others completely miss contact with the surface of the multi-cell device. While the multiple probe tips could of course be rendered co-planar by a precision grinding operation, the resulting probe tips would have different contact areas and hence different electrical characteristics. Additionally, the alignment of such a ganged probe is also problematical. In other types of circuits, such ganged probes achieve alignment by gripping or otherwise contacting the edges of the circuit to be tested on three points. However, mechanically contacting three edge points of the ceramic sheet of a multi-cell fuel cell has great potential to cause edge damage to the ceramic sheet or create future locations of crack propagation.

Clearly, there is a need for a technique for quickly and reliably checking the circuitry of a multi-cell, ceramic sheet type fuel cell without the use of time-consuming hand-probing, and without the potential for point stress damage or edge damage on the ceramic sheet. Ideally, such a technique would be easily adaptable to different sizes of ceramic sheet type fuel cells with different numbers of cells. Finally, it would be desirable if such a technique were easily and inexpensively implemented without the need for precision probe-planarizing techniques.

### SUMMARY OF THE INVENTION

Generally speaking, the invention is a circuit testing device for multi-cell solid oxide fuel cells that overcomes or at least ameliorates all of the aforementioned shortcomings associated with the prior art. To this end, the inventive circuit testing device includes a support member having a face that conforms to the surface of the multi-cell solid oxide fuel cell, and a plurality of resilient contacts mounted on the face of the support member, the contacts being spaced-apart so that each contact is individually registrable with one of the multiple cells on the outer surface of the fuel cell. The resilient contacts are electrically connected to an ohm meter or other electrical measuring device.

The support member includes a light conducting portion that visually facilitates alignment and engagement between said resilient contact members and the individual cells of the solid oxide fuel cell when the device is positioned over the solid oxide fuel cell. The light conducting portion of the support member may be a transparent material that forms all or part of the member, or one or more apertures in the member that allow it to be positioned over the solid oxide fuel cell such that the desired alignment between the resilient contacts and the cells is achieved. Preferably, the number of resilient contacts is the same as the number of cells in the fuel cell to allow the device to rapidly test for short circuits between the cells via a simple, two step operation which includes the positioning of the device over the fuel cell, and the actuation of the ohm meter.

The resilient contacts preferably engage a sufficiently broad area of the cells (for example, between 1.0 and 10.0 cm²) to avoid localized stresses in the ceramic sheet-type solid oxide fuel cell that could otherwise provide sites for unwanted cracking or other types of damage. Each of the resilient contacts preferably includes a resilient member formed by an elastomeric material covered at least in part by a flexible conductive material, such as a wire mesh. Additionally, the support member is preferably of a weight selected so as to conductively engage the resilient contacts against the outer surfaces of the cells of the solid oxide fuel cells when the device overlies said cell-bearing surface of said solid oxide fuel cell.

The circuit testing device is particularly well adapted to testing multi-cell, ceramic sheet type solid oxide fuel cells for short circuits between the cells. Accordingly, in a preferred embodiment, the support member is a support plate formed from a non-conductive, transparent material having a length and width which is the same or slightly larger than the length and width of the array of cells on the surface of the ceramic sheet-type solid oxide fuel cell. One or more handles may be mounted on the support plate to facilitate the desired positioning and alignment of the resilient contacts on the array of cells. A resilient pad may be mounted on the face of the support plate in a position opposite to the resilient contacts to prevent the face from contacting said cell-bearing surface of said solid oxide fuel cell.

The circuit testing device can quickly and reliably test all the cells of a ceramic sheet-type solid oxide fuel cell simultaneously without the application of stresses on the fragile edges of such cells, and without the application of point-type stresses on the surface of the fuel cell that can form sites for unwanted cracking or other damage.

### DESCRIPTION OF THE SEVERAL DRAWINGS

FIG. 1 is a plan view of the testing device of the invention shown without the ohm meter that is connected to the leads of the resilient contacts;

FIG. 2 is a cross-sectional view of the device illustrated in FIG. 1 along the section line 2-2, illustrating how the resilient contacts are individually registrable with the multiple cells of a ceramic sheet-type solid oxide fuel cell;

FIG. 3 is a cross-sectional view of the device illustrated in FIG. 1 along the section line 3-3, illustrating the extent to which the resilient contacts overlie their respective cells;

FIG. 4 is an enlargement of the area circled in phantom of FIG. 2, illustrating a cross-sectional view of the resilient contacts, and their shape prior to engagement with the multiple cells of the ceramic sheet-type solid oxide fuel cell;

FIG. 5 is an enlargement of the area boxed in phantom of FIG. 3, illustrating a side view of the resilient contacts prior to engagement with the multiple cells of the ceramic sheet-type solid oxide fuel cell;

FIG. 6 is a cross-sectional view of the resilient contacts upon their engagement with the multiple cells of the ceramic sheet-type solid oxide fuel cell, illustrating how their shape changes upon such engagement to provide a broad area of mechanical and electrical contact with the cells, and

FIG. 7 is a plan view of an alternative embodiment of the circuit testing device in operation.

### DETAILED DESCRIPTION OF THE PREFERRED EMBODIMENTS

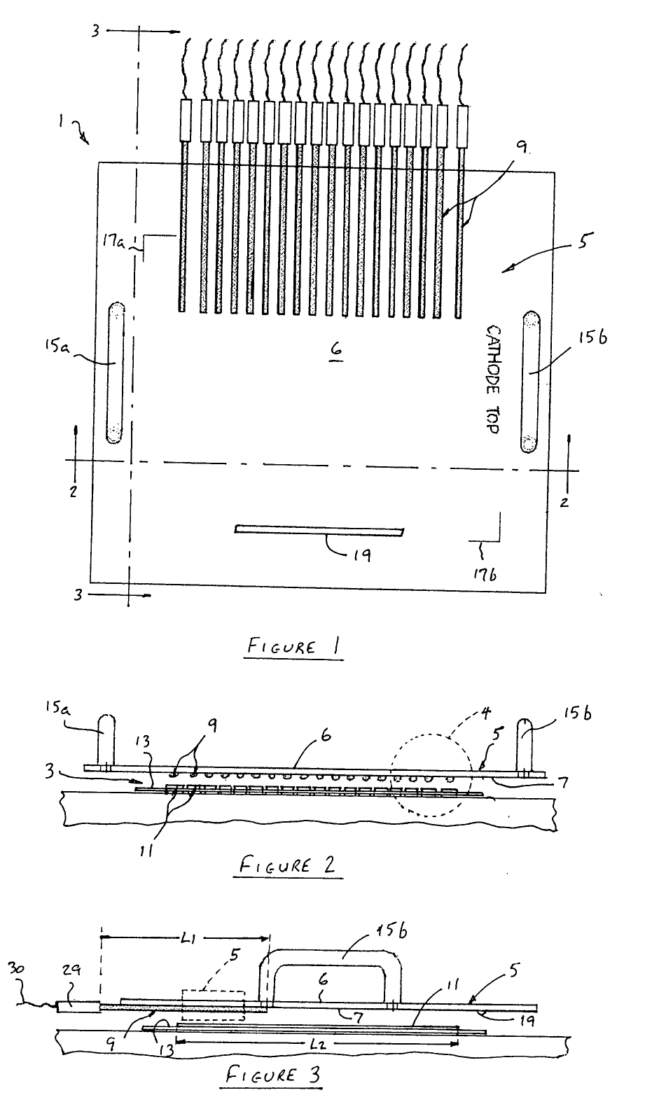

With reference now to FIGS. 1 and 2, wherein like numerals designate like components throughout all the several Figures, the circuit testing device 1 of the invention is particularly adapted for testing the circuitry of multi-cell, ceramic sheet-type solid oxide fuel cells 3. To this end, the circuit testing device 1 includes a support member in the form of support plate 5, although the support member may assume shapes other than a flat plate shape. Plate 5 is preferably formed from a transparent, non-conducting material such as Plexiglas® in order to provide a light conducting portion 6 for a purpose described hereinafter, although the device 1 could also be made to operate if the plate 5 were made of a translucent material with the properties of tracing paper. The length and width of the plate 5 should be selected so that it completely covers and overlaps the sheet-type fuel cell (as shown in FIG. 7). The number of resilient contacts 9 is the same as the number of cells 11 in the fuel cell 3. As is best seen with respect to FIG. 2, the longitudinal edges of the resilient contacts 9 are spaced apart such that each contact 9 is individually registrable with one of the cells 11 on the upper side 13 of the sheet-type fuel cell 3. A pair of handles 15a, 15b is mounted on the top side of the support plate 5 as shown to facilitate positioning of the device 1 over the sheet-type fuel cell 3. Right-angle hatch marks 17a, 17b are also provided on the top side of the support plate 5 and are positioned such that alignment of the corners of the sheet-type fuel cell 3 with the hatch marks 17a, 17b will result in the registration of the resilient contacts 9 with the cells 11 (as may be seen in FIG. 7).

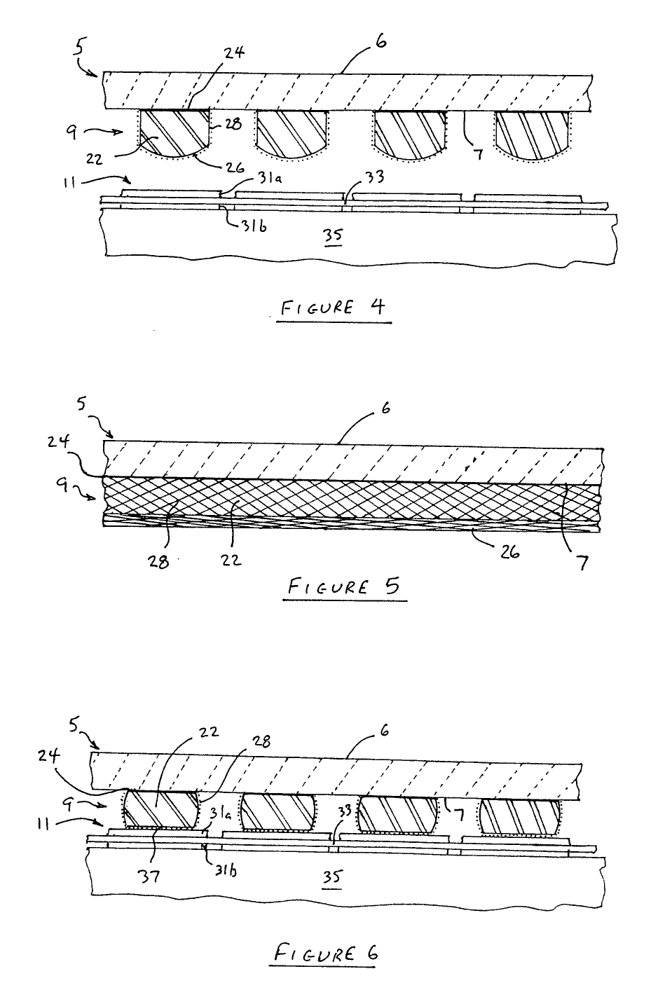

With reference now to FIG. 3, the length L1 of the resilient contacts 9 should be selected such that between about 15% and 60% of the length L2 of the cells 11 is engaged by the contacts 9 when the device 1 overlies the sheet-type fuel cell 3 in the testing position illustrated in FIG. 7. Such a broad contact area not only prevents potentially damaging point type contact between the contacts 9 and the cells 11, but also insures good electrical contact during testing. A strip-shaped balancing pad 19 (which is preferably formed from the same elastomeric material in the contacts 9) is mounted on the face 7 of the support plate 5 on the side opposite to the resilient contacts 9 and in a non-conductive area (no cells 11) of fuel cell 3. The purpose of the balancing pad 19 is to prevent direct contact between the face 7 of the support plate 5 and the upper surface 13 of the sheet-type fuel cell 3 during the testing operation, which could result in damaging scraping.

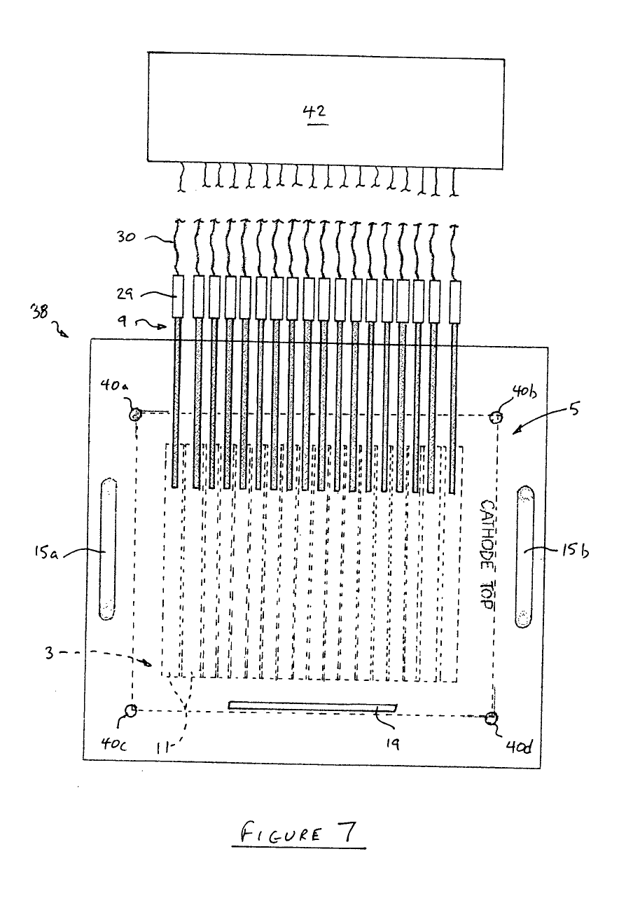

FIGS. 4 and 5 illustrate the resilient contacts 9 just prior to engagement with the upper electrode surfaces 31a of the cells 11, which are supported by the ceramic electrolyte sheet 33. The resilient contacts 9 each include an elastomeric member 22 mounted to the face 7 of the support plate 5 by a layer 24 of adhesive. In the preferred embodiment, the elastomeric member 22 of each of the contacts 9 may be formed from commercially available gasket material, such as Chomerics Softshield 5000 gasket material, part number 82-121-74018-09600, sold by the Chomerics Division of Parker Hannifin Corporation, located in Woburn, Mass. Such gasket material comes in rod form with a self-sticking layer of adhesive. Preferably, the elastomeric member 22 has a slightly rounded bottom 26 as shown. Member 22 is wrapped in a conductive wire mesh 28 as shown, although other flexible conductive sheet materials may also be used. Preferably, the wire mesh 28 is formed from a corrosion resistant metal, such as nickel. Each of the contacts includes a terminal 29 at its back end where the wire mesh 28 is connected to a lead wire 30 (shown in FIGS. 3 and 7). The weight of the support plate 5 is selected such that the rounded bottom 26 of the contacts 9 is compressed into broad and flat contact 37 with the upper electrode layer 31a of the cells 11 when the device 1 is positioned over a sheet type fuel cell 3, as is illustrated in FIG. 6.

FIG. 7 illustrates a second embodiment 38 of the device wherein apertures 40a, 40b, 40c, and 40d constitute the light conducting portion of the support plate 5. Alignment is achieved between the resilient contacts 9 and the cells 11 when the apertures 40a, 40b, 40c, and 40d are aligned with the corners of the sheet-type fuel cell 3 of the fuel cell. Alternatively, the light conducting portion of the support plate may be an array of small holes extending over most or all of the face 7 of the support plate 5 that would allow the operator of the device 38 to see through the plate 5 with sufficient resolution to easily align the contacts 9 with the cells 11.

In operation, the operator uses the handles 17a and 17b to position the support plate 5 of the device 1 or 38 in the position shown in FIG. 7, with the resilient contacts 9 in individual registration with each of the cells 11. An ohm meter 42 is connected to each of the lead wires 30 of the contacts as shown. The weight of the support plate 5 engages the bottoms 26 of each contact 9 in broad and flat engagement with a cell 11 as shown in FIG. 6. The ohm meter is actuated in order to confirm whether the amount of electrical resistance between the electrode layers 31a of adjacent cells is between a predetermined range indicative of defect free circuitry. In the case of a non-series strip cell design, the device 1, 38 is removed, the sheet-type fuel cell is flipped over, and the operation is repeated for the electrode layers. Hence the device 1 can be used to test either face of the fuel cell 3.

Different modifications, additions, and variations of this invention may become evident to the persons in the art. For example, for a tubular strip-cell design, the plate 5 could be curved into a semi-cylindrical shape so that the resilient contacts 9 register with and electrically engage each of the cells of such a fuel cell. Again, the plate 5 could be formed of a transparent material or have one or more light conducting sections to allow the operator of the device to visually align the resilient contacts 9 with the individual cells of such a structure. All such variations, additions, and modifications are encompassed within the scope of this invention, which is limited only by the appended claims, and the equivalents thereto.

What is claimed:

1) A device for testing the circuitry of a solid oxide fuel cell having a surface that bears a plurality of spaced-apart electrically connected cells, comprising:
a support member having a face that conforms to said cell-bearing surface of said solid oxide fuel cell;
a plurality of resilient contacts mounted on said face of said support member, said contacts being spaced-apart such that each contact is individually registrable with one of said plurality of spaced-apart cells, and
a light conducting portion in said support member that visually facilitates alignment and engagement between said resilient contact members and said cells when said support member is positioned over said cell-bearing surface of said solid oxide fuel cell.

2) The testing device of claim 1, wherein said face of said support member is flat to conform to a flat, cell-bearing surface of said solid oxide fuel cell.

3) The testing device of claim 1, wherein said support member includes a support plate.

4) The testing device of claim 1, wherein said support member is of a weight selected so as to apply a sufficient force on said resilient contacts to conductively engage them against said cells of said solid oxide fuel cells when said device overlies said cell-bearing surface of said solid oxide fuel cell.

5) The testing device of claim 1, wherein said light conducting portion of said support member includes a portion of said support member formed from a light conducting material.

6) The testing device of claim 1, wherein said light conducting portion of said support member includes one or more apertures in said support member.

7) The testing device of claim 1, wherein said resilient contacts include a resilient member covered at least in part by a flexible conductive material.

8) The testing device of claim 1, wherein each of said resilient contacts engages at least 1.0 cm² of the area of one of the cells of said solid oxide fuel cell to avoid the generation of localized stress on the fuel cell during testing.

9) The testing device of claim 7, wherein said resilient member includes an elastomeric material and said conductive material includes a metallic mesh.

10) The testing device of claim 1, further comprising a resilient pad mounted on said face of said support member in a position opposite to said resilient contacts to prevent said face from contacting said cell-bearing surface of said solid oxide fuel cell.

11) A device for testing the circuitry of a solid oxide fuel cell of a type formed on a thin, flexible ceramic sheet and having a surface including an array of spaced-apart electrically connected cells, comprising:
a support plate having a substantially flat face;
a plurality of resilient contacts mounted on said face of said support plate, said contacts being spaced-apart so that each contact is individually registrable with one of said plurality of spaced-apart cells, and
a light conducting portion in said support plate that visually facilitates alignment and engagement between said resilient contact members and said cells when said support member is positioned over said surface of said solid oxide fuel cell.

12) The testing device of claim 11, wherein said light conducting portion of said support plate includes a portion of said support member formed from a light conducting material.

13) The testing device of claim 12, wherein said light conducting material includes a transparent material.

14) The testing device of claim 11, wherein said support plate is of a weight selected so as to apply a sufficient force on said resilient contacts to conductively engage them against said cells of said solid oxide fuel cells when said device overlies said surface of said solid oxide fuel cell.

15) The testing device of claim 11, wherein said resilient contacts include a resilient member covered at least in part by a flexible conductive material.

16) The testing device of claim 11, further comprising a resilient pad mounted on said face of said support plate in a position opposite to said resilient contacts to prevent said face from contacting said surface of said ceramic sheet-type solid oxide fuel cell.

17) The testing device of claim 11, further comprising a handle mounted on said support plate for facilitating positioning of said resilient contacts over said cells.

18) The testing device of claim 11, wherein the support plate is at least long enough to traverse said array of electrically connected cells, and includes one resilient contact for every cell on said surface such that all of said cells may be tested simultaneously.

19) The testing device of claim 11, further comprising an electrical resistance meter connected to said resilient contacts.

20) A device for testing the circuitry of a solid oxide fuel cell of a type formed on a thin, flexible ceramic sheet and having a surface that includes an array of spaced-apart electrically connected cells, comprising:
a support plate having a substantially flat face and being formed from a transparent, non-conductive material;
a plurality of resilient contacts mounted on said face of said support plate, said contacts being spaced-apart so that each contact is individually registrable with one of said plurality of spaced-apart cells,
wherein said support plate is of a weight selected so as to apply a sufficient force on said resilient contacts to conductively engage them against said cells of said solid oxide fuel cells when said device overlies said surface of said solid oxide fuel cell.
